(19) United States
(12) Patent Application Publication
(10) Pub. No.: US 2024/0337298 A1
(43) Pub. Date: Oct. 10, 2024

(54) VIBRATION ISOLATION ASSEMBLY

(71) Applicant: Roof Goose Vent LLC, North Kingstown, RI (US)

(72) Inventor: Jack F. KING, JR., North Kingstown, RI (US)

(73) Assignee: Roof Goose Vent LLC, North Kingstown, RI (US)

(21) Appl. No.: 18/630,596

(22) Filed: Apr. 9, 2024

Related U.S. Application Data
(60) Provisional application No. 63/458,216, filed on Apr. 10, 2023.

(51) Int. Cl. F16F 1/44; F16F 1/36; F16F 1/376

(52) U.S. Cl. CPC F16F 1/44; F16F 1/3605; F16F 1/376; F16F 2224/025; F16F 2230/0029

(57) ABSTRACT

A vibration isolation assembly is useful with dimensional lumber such as pressure treated lumber used as dunnage for placing air conditioners and other rooftop mounted equipment. The assembly includes a support member and a rubber isolator member adapted to engage the support member.

### RELATED APPLICATION

This application claims the benefit of U.S. Provisional Application Ser. No. 63/458, 216, filed Apr. 10, 2023, entitled “Vibration Isolation Assembly,” which is incorporated herein by reference in its entirety.

### FIELD OF THE INVENTION

The present invention relates to a vibration isolation assembly. More particularly, the invention relates to a vibration isolation assembly for dimensional lumber such as pressure treated lumber used as dunnage for placing air conditioners and other rooftop mounted equipment.

### BACKGROUND OF THE INVENTION

Various types of vibration isolation devices are known in the art. For example, devices are known which comprise a laminate rubber with a cork pad and which rely on downward pressure to keep the device in position. Additionally, devices are known which consist of a fixed cast iron carrier assembly enclosing different spring capacities in order that the isolator can properly match the weight of the equipment to be supported. However, there are no known rubber devices used for specific mounting points for the lumber holding the rooftop equipment.

These known devices have various shortcomings and improvement is needed for vibration isolation assemblies for mounting rooftop equipment. These and other shortcomings of these devices are addressed by the present invention.

### SUMMARY OF THE INVENTION

A primary object of the present invention is to provide a vibration isolation assembly for dimensional lumber used as dunnage for rooftop mounted equipment, including air conditioners.

Another primary object of the present invention is to provide a vibration isolation assembly that allows fastening to the lumber by virtue of a two-piece design which allows for supporting different weight capacities of the rooftop mounted equipment.

Another primary object of the present invention is to provide for a vibration isolation assembly for dimensional lumber having a two-piece design comprising a support and an isolator.

Another primary object of the present invention is to provide for a vibration isolation assembly for dimensional lumber having a two-piece design comprising a support and an isolator wherein the isolator is comprised of rubber and different durometers of the rubber may be used to support different weight capacities of the rooftop mounted equipment.

The present invention is directed to a vibration isolation assembly comprising a support member and an isolator member wherein the isolator member is selected from rubbers having different durometers.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1A is a perspective view of the vibration isolation assembly.

FIG. 1B is an end view of the vibration isolation assembly of FIG. 1A.

FIG. 1C is a side view of the vibration isolation assembly of FIG. 1B along line A-A.

FIG. 2A is a perspective exploded view of the vibration isolation assembly of FIG. 1A.

FIG. 2B is a side exploded view of the vibration isolation assembly of FIG. 2A.

FIG. 3A is a perspective view of the support of the vibration isolation assembly of FIG. 1A.

FIG. 3B is a bottom/side perspective view of the support of FIG. 3A.

FIG. 3C is a top view of the support of FIG. 3A.

FIG. 3D is a side view of the support of FIG. 3A.

FIG. 3E is a bottom view of the support of FIG. 3A.

FIG. 4A is a perspective view of the isolator of the vibration isolation assembly of FIG. 1A.

FIG. 4B is a top view of the isolator of FIG. 4A.

FIG. 4C is a side view of the isolator of FIG. 4A.

FIG. 5A is a perspective view of the vibration assembly of FIG. 1A installed and holding an air conditioner.

FIG. 5B is a side view of FIG. 5A.

FIG. 5C is an end view of FIG. 5A.

FIG. 5D is a top view of FIG. 5A.

FIG. 6A is another perspective view of the vibration assembly of FIG. 1A installed and holding two air conditioners.

FIG. 6B is a side view of FIG. 6A.

FIG. 6C is an end view of FIG. 6A.

FIG. 6D is a top view of FIG. 6A.

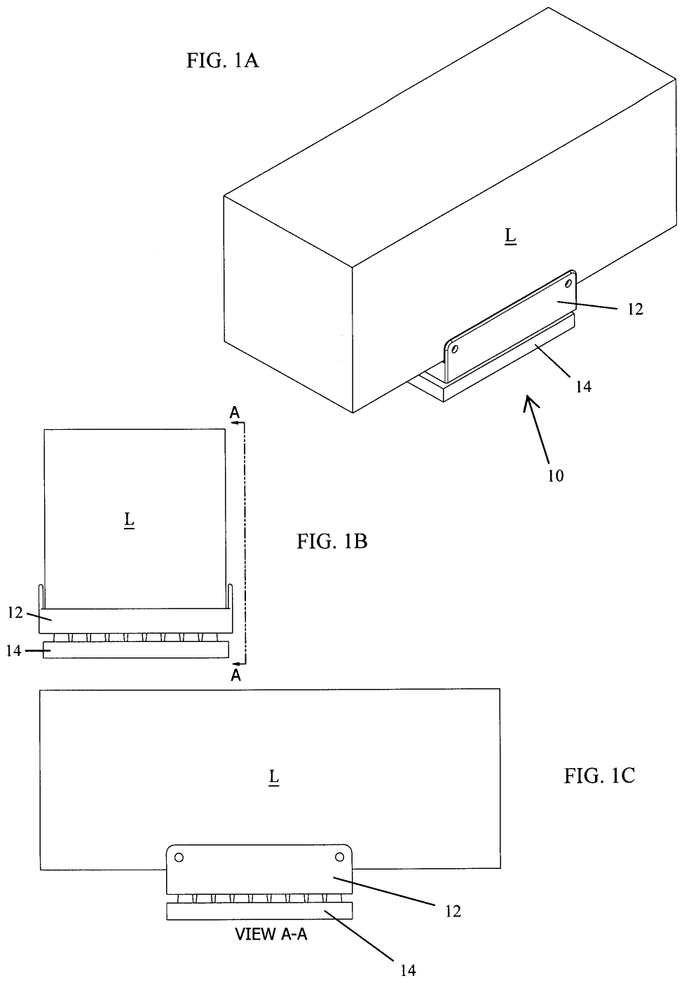

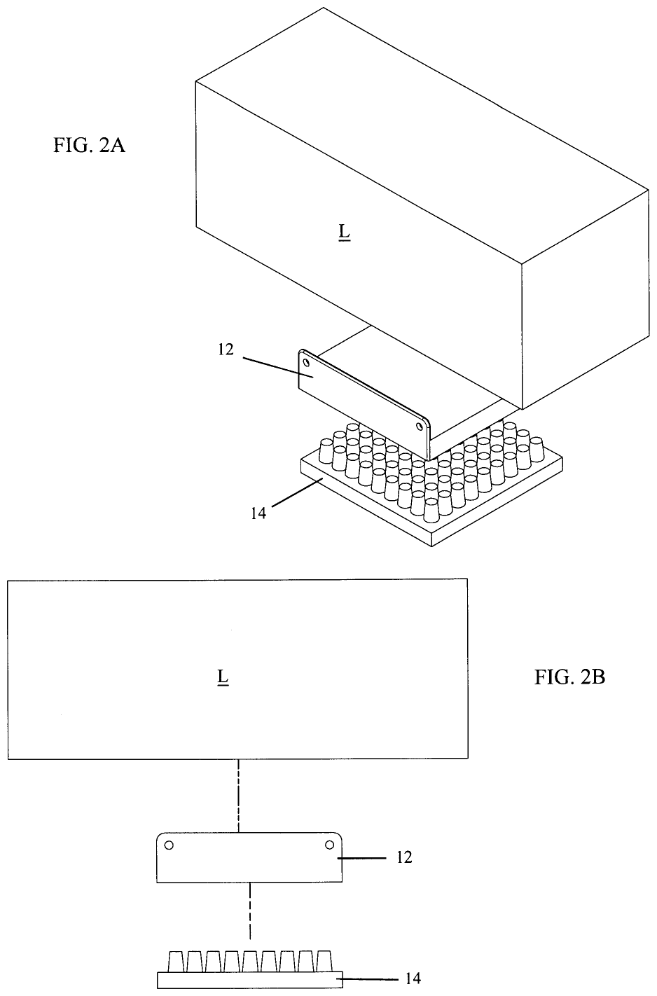

### DETAILED DESCRIPTION OF THE PREFERRED EMBODIMENTS

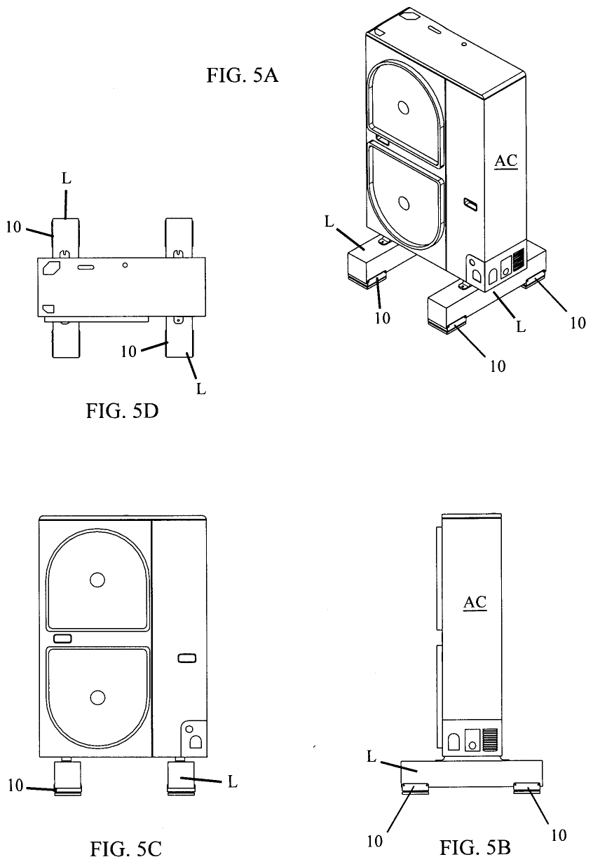

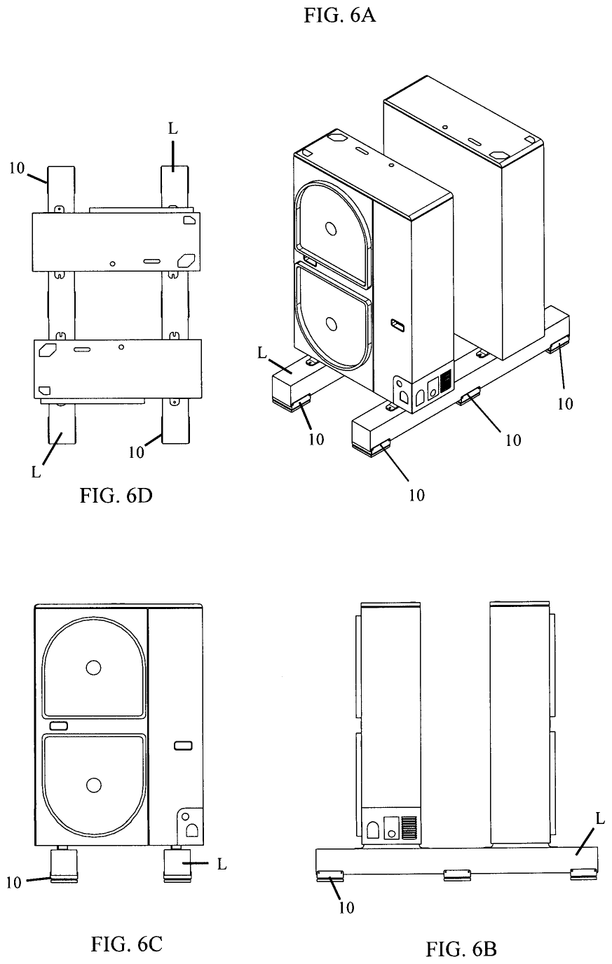

The present invention is directed to a vibration isolation assembly 10. More particularly, the invention is directed to a vibration isolation assembly for dimensional lumber L such as pressure treated lumber used as dunnage for placing air conditioners AC and other rooftop mounted equipment as shown in FIGS. 5 and 6.

Referring to the figures, there is shown a vibration isolation assembly 10. The vibration isolation assembly includes a support 12 and an isolator 14. The support 12 may be made of a molded rubber such as Santoprene®. The isolator 14 is also made of a rubber such as Santoprene®. The isolator will be made of a rubber having different durometers depending on the weight of the equipment to be supported.

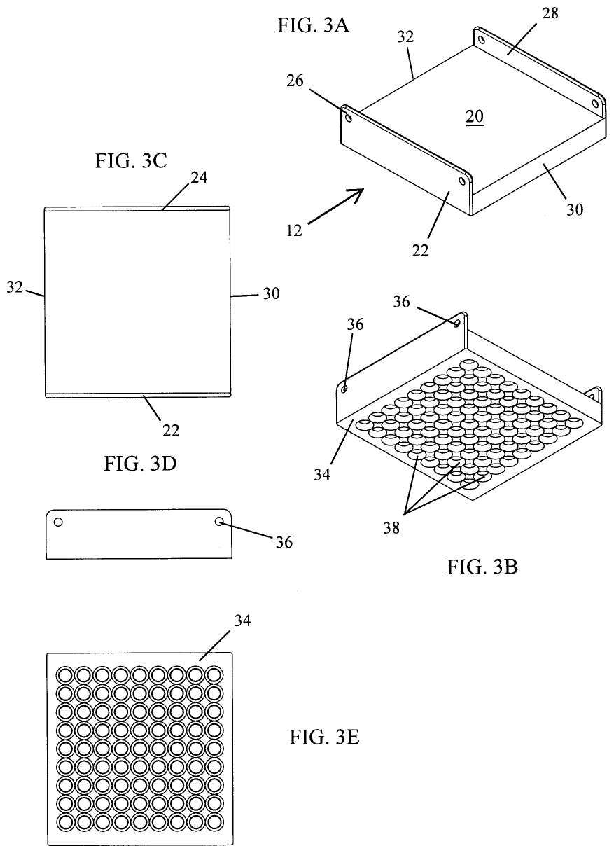

The support 12 is a universal member to be used with isolators 14 having different durometers. Referring, for example, to FIGS. 3A-3E, support 12 includes a top 20, sides 22 and 24 with flaps 26 and 28, ends 30 and 32 and a bottom 34. The flaps 26,28 include apertures 36 for fastening the support to lumber L. Bottom 34 includes a plurality of openings 38 for receiving posts of the isolator 14 as discussed hereafter. The openings 38 are preferably arranged in a plurality of rows. The openings 38 may be circular or other shapes. The openings in one embodiment may be about 0.437 inches and are circular.

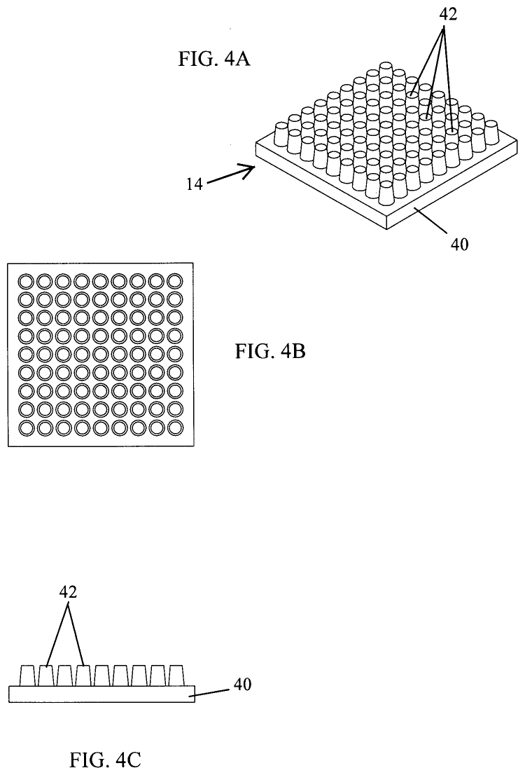

Isolator 14 may be made of a molded rubber having different durometers depending on the weight of the rooftop equipment requiring support. Referring, for example, to FIGS. 4A-4C, isolator 14 includes a base 40 and posts 42. The posts 42 are sized and adapted to fit into openings 38 of support 12 by friction fit. The posts 42 are preferably arranged in a plurality of rows. The posts 42 may be conical or other shapes. The posts 42 in one preferred embodiment may be about 0.375 inches to fit into the openings. The isolator 14 when used in conjunction with support 12 will dampen lateral vibration by virtue of the posts 42 that can compress down as well as vibrate side to side all without a hard or glued connection for mating isolator 14 with support 12.

Referring to FIGS. 5 and 6, there are shown two installations for holding rooftop equipment such as air conditioners AC using multiple vibration isolator assemblies 10. The assemblies 10 are fastened to the lumber L by fasteners through apertures 36 of support 20. The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. A vibration isolation assembly comprising a support member having a top wall adapted to engage a piece of lumber or other dunnage material and a bottom wall having a plurality of openings, and an isolator member made of rubber having a base and a plurality of posts adapted to engage and fit into the plurality of openings of the support, wherein the isolator member is selected from rubbers having different durometers.

2. The vibration isolation assembly of claim 1 wherein the support is made of rubber.

3. The vibration isolation assembly of claim 1 wherein the support member and the isolator member are made of Santoprene®.

4. The vibration isolation assembly of claim 1 wherein the support comprises the top wall, the bottom wall, a first side, a second side, a first end, a second end, and at least one flap for fastening the support to the lumber or other dunnage material.

5. The vibration isolation assembly of claim 4 wherein the support includes two flaps.

6. The vibration isolation assembly of claim 1 wherein the plurality of openings are in the range of three to five inches.

7. The vibration isolation assembly of claim 1 wherein the plurality of openings are arranged in rows and are circular and the plurality of posts are arranged in rows and are conical.

8. A vibration isolation assembly comprising a support member made of rubber having a top wall adapted to engage a piece of lumber or other dunnage material and a bottom wall having a plurality of openings and having a flap on each side of the top wall for fastening the support member to the lumber or other dunnage material, and an isolator member made of rubber having a base and a plurality of posts adapted to engage and fit into the plurality of openings of the support member, wherein the isolator member is selected from rubbers having different durometers.

9. The vibration isolation assembly of claim 8 wherein the plurality of openings are in the range of three to five inches.

10. The vibration isolation assembly of claim 9 wherein the support member and the isolator member are made of Santoprene®.

11. The vibration isolation assembly of claim 8 wherein the plurality of openings are arranged in rows and are circular and the plurality of posts are arranged in rows and are conical.
